(19) United States
(12) Patent Application Publication
(10) Pub. No.: US 2004/0081075 A1
(43) Pub. Date: Apr. 29, 2004

(54) Code modulation adaptive and variable multiplexing transmission method and code modulation adaptive and variable multiplexing transmission apparatus

(76) Inventor: Kazuaki Tsukakoshi, Kashiwa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/685,531

(22) Filed: Oct. 16, 2003

(30) Foreign Application Priority Data
Oct. 18, 2002 (JP) 2002-303798

(51) Int. Cl. H04J 11/00

(52) U.S. Cl. 370/206

(57) ABSTRACT

A code-modulation adaptive and variable multiplexing transmission apparatus. Dividing circuit divides transmission information data into plural transmission sub-channel signals. Coder performs error-correction coding by coding scheme and coding ratio selected from plural schemes and plural ratios for each sub-channel. Modulator performs primary modulation by selecting a multi-level modulation scheme from plural schemes for each sub-channel. Another modulator performs band-broadening by selecting a band-broadening scheme from plural schemes for each sub-channel. Adding circuit adds transmission-condition identifying information including coding scheme and coding ratio, multi-level modulation scheme in the primary modulation, band-broadening scheme in the secondary modulation on each sub-channel, and the number of the sub-channels. Multiplexing circuit frequency-multiplexes plural modulated outputs, so that they are frequency-multiplexed and transmitted.

### BACKGROUND OF THE INVENTION

The present invention relates to code-modulation multiplexing transmission technologies. More particularly, it relates to a code-modulation adaptive and variable multiplexing transmission method and apparatus that allows high-speed information or data to be transmitted with a high efficiency under different transmission conditions such as the situation on a transmission path, many types of media, or many types of services.

A conventional code-modulation adaptive and variable transmission apparatus, which has been disclosed in, e.g., JP-A-2000-183849, JP-A-10-224322, and JP-A-11-234241, performs the transmission such that transmission information data in units of a slot or a packet consisting of plural slots is error-correction coded using a coding scheme and at a coding ratio that are selected from among plural coding schemes and coding ratios prepared in advance, is then subjected to a primary modulation by a multi-level modulation scheme selected from plural multi-level modulation schemes, and is finally transmitted after being subjected to a secondary modulation wherein the transmission information data is converted into a band-broadened transmission signal for transmission.

Reference may further be made to JP-A-10-145282, WO99/14878 (JP-A-2001-517017), and JP-A-9-135275 for related technologies.

In the multimedia communications in recent years, there has been an increasing demand for the Internet traffic. This has been causing an increasing demand for faster data packet transmission technologies. The necessity for implementing faster data transmission has resulted in the introduction of technologies such as an adaptive modulation where the multi-level modulation is adopted. Accordingly, a code-modulation adaptive and variable transmission apparatus like the one described above has been devised which employs the scheme of selectively switching a coding scheme and a coding ratio of a coder and a multi-level modulation scheme of a primary modulator.

### SUMMARY OF THE INVENTION

Hereinafter, explanation will be given below concerning a code-modulation adaptive and variable transmission apparatus that the present inventor has investigated in the process of achieving the present invention. FIG. 3 illustrates the configuration of a transmission unit of this code-modulation adaptive and variable transmission apparatus, and FIG. 4 illustrates the configuration of a reception unit thereof.

First, referring to FIG. 3, explanation will be given below regarding the configuration of the transmission unit. In FIG. 3, when transmission information data 301 in units of a slot or in units of a packet is inputted, based on data rate, data capacity of the transmission information data 301, or transmission-condition specifying information included in the information data, a transmission-condition identifying circuit 306 identifies transmission-condition information 307, such as the data rate and data capacity, then outputs the identified transmission-condition information 307 to a transmission-unit controlling circuit 308. Then, based on a transmission-unit controlling signal 309 that follows this transmission-condition information 307, the transmission-unit controlling circuit 308 performs a control of switching the coding scheme and coding ratio of error correction of a coder 303, a control of switching the multi-level modulation scheme of a primary modulator 304, and a control of a transmission-condition-identifying-information adding circuit 310. Although illustration is omitted, there also exists a transmission apparatus which is provided with a means for monitoring the transmission situation and traffic situation on a transmission path so that transmission conditions conforming to the transmission-line situation may be assigned to the transmission-unit controlling circuit 308.

Through the above-described control, the transmission information data 301 is transformed into a transmission signal 312 in the following manner: In a transmission channel 302, first, the inputted transmission information data 301 is coded in the coder 303 in accordance with a selected and set-up coding scheme and coding ratio of error correction. Next, in the primary modulator 304, the coded data is primary-modulated in accordance with a selected and set-up multi-level modulation scheme. Then, in the transmission-condition-identifying-information adding circuit 310, transmission-condition identifying information 311 in the form of data converted into a command or the like, is added to the modulated data. Finally, in a secondary modulator 305, the data is band-broadened in accordance with a secondary modulation scheme such as OFDM (Orthogonal Frequency Division Multiplex) or spread modulation by spread coding, and the resultant band-broadened data is outputted as the transmission signal 312. The signal 312 transmitted from the transmission channel 302 in this way will be received at the reception unit.

In the reception unit in FIG. 4, in a reception channel 402, a reception signal 401 is inputted into a secondary demodulator 403 and a secondary demodulation, such as the OFDM or the spread demodulation, is performed so as to restore the reception signal back to the multi-level-modulated signal. Next, a transmission-condition identifying circuit 406 identifies transmission-condition identifying information 407 added to the signal and then outputs identified transmission-condition information 408 to a reception-unit controlling circuit 409. In response to a reception-unit controlling signal 410 from the reception-unit controlling circuit 409, a multi-level demodulation of a primary demodulator 404 is selected and switched, so that the multi-level-modulated signal outputted from the secondary demodulator 403 may be converted into the coded data. Further, a decoding scheme and a coding ratio of error correction of a decoder 405 is selected and switched, so that the coded data may be transformed into reception information data 411 and outputted from the decoder 405.

In this transmission apparatus, unlike the primary modulation, the secondary modulation scheme of the above-described secondary modulator 305 is fixed without being selected and switched.

In this code-modulation adaptive and variable transmission apparatus, however, the implementation of the faster data transmission requires not only further speeding-up of processing operations of the coder, the primary modulator, and the secondary modulator in the transmission channel, but also further speeding-up of processing operations of the decoder, the primary demodulator, and the secondary demodulator in the reception channel. This requirement would necessitate even more speeding-up in the component parts of the processing circuits, especially in an AD (Analogue-to-Digital) converter in the transmission unit and a DA (Digital-to-Analogue) converter in the reception unit where the speeding-up is difficult to accomplish.

Also, in the faster data transmission, with the selection and switching of a coding scheme and a coding ratio of the coder and the selection and switching of a multi-level modulation scheme of the primary modulator, it is impossible to perform a detailed adaptive control in response to various transmission conditions on the information data and variations in the transfer situation and traffic situation on the transmission path. Accordingly, there also exists a problem of a decreased enhancement in the frequency utilization efficiency.

It is an object of the present invention to provide a code-modulation adaptive and variable multiplexing transmission method and apparatus that allows the implementation of faster data transmission without speeding up the coding operation, the primary modulation, and the secondary modulation in the transmission unit, or the decoding operation, the primary demodulation, and the secondary demodulation in the reception unit.

It is another object of the present invention to provide a code-modulation adaptive and variable multiplexing transmission method and apparatus that allows faster information data to be transmitted with a high efficiency in response to different transmission conditions such as the situation on a transmission path, many types of media, or many types of services.

A code-modulation adaptive and variable multiplexing transmission apparatus according to one aspect of the present invention includes:

a data dividing circuit for dividing transmission data into transmission signals on plural transmission sub-channels;

a primary modulator and a secondary modulator provided for each of the plural transmission sub-channels, the primary modulator performing a multi-level modulation to a transmission signal on the transmission sub-channel transmitted from the data dividing circuit, the secondary modulator performing a transmission-band-broadening on a multi-level-modulated signal acquired from the primary modulator;

an addition circuit for adding transmission-condition information to each transmission signal of an associated transmission sub-channel, the transmission-condition information including a multi-level modulation scheme of the primary modulator and a band-broadening scheme of the secondary modulator for each of the plural transmission sub-channels, and the number of the plural transmission sub-channels; and

a frequency multiplexing circuit for frequency-multiplexing band-broadened multi-level-modulated outputs acquired from the respective secondary modulators on the plural transmission sub-channels, and outputting a resultant frequency-multiplexed signal as a channel for a user.

According to one preferable characteristic of the present invention, the primary modulator provided for each of the plural transmission sub-channels is arranged to select an arbitrary multi-level modulation scheme from among plural multi-level modulation schemes. Also, the secondary modulator provided for each of the plural transmission sub-channels is arranged to select an arbitrary band-broadening scheme from among plural band-broadening schemes.

According to another preferable characteristic of the present invention, a coder is provided at a preceding stage of the primary modulator provided for each of the plural transmission sub-channels, the coder performing an error-correction coding on the transmission signal on a transmission sub-channel associated therewith, the primary modulator performing the multi-level modulation to output data outputted from the coder.

According to another preferable characteristic of the present invention, the coder is arranged to select an arbitrary error-correction coding scheme and an arbitrary coding ratio from among plural error-correction coding schemes and plural coding ratios, respectively.

A code-modulation adaptive and variable multiplexing transmission apparatus according to another aspect of the present invention includes:

a frequency separating circuit for frequency-separating a received frequency-multiplexed signal into a modulated signal for each of plural reception sub-channels;

a transmission-condition identifying circuit for identifying transmission-condition information added on a transmission side, the transmission-condition information including a multi-level modulation scheme in the primary modulation for each reception sub-channel, a band-broadening scheme in the secondary modulation for each reception sub-channel, and a number of reception sub-channels;

a controlling circuit for generating a controlling signal on the basis of the transmission-condition information identified in the transmission-condition identifying circuit;

a secondary demodulator and a primary demodulator both provided for each of the plural reception sub-channels,

wherein the secondary demodulator, responsive to the controlling circuit, demodulates a modulated signal of associated reception sub-channel acquired from the frequency separating circuit with a band-debroadening scheme corresponding to the band-broadening scheme identified in the transmission-condition identifying circuit,

and wherein the primary demodulator, responsive to the controlling circuit, demodulates a signal from the secondary demodulator with a multi-level demodulation scheme corresponding to the multi-level modulation scheme identified in the transmission-condition identifying circuit; and

a data combining circuit for combining data acquired from the plural reception sub-channels.

A code-modulation adaptive and variable multiplexing transmission method according to another aspect of the present invention includes the steps of:

dividing transmission data into transmission signals on plural transmission sub-channels;

performing a multi-level modulation to each of the transmission signals on the plural transmission sub-channels;

performing a transmission-band-broadening to each of multi-level-modulated signals on the plural transmission sub-channels;

adding transmission-condition information to each transmission signal, the transmission-condition information including a modulation scheme of the multi-level modulation, a modulation scheme of the band-broadening, and the number of the plural transmission sub-channels; and

frequency-multiplexing band-broadened modulated outputs on the plural transmission sub-channels, and outputting a resultant signal as a channel for one and the same user.

In the code-modulation adaptive and variable multiplexing transmission apparatus according to the present invention explained above, in the transmission unit, the transmission information data is divided onto the plural transmission sub-channels so that the following operations are performed on each transmission sub-channel basis: the coding in accordance with a selected and switched coding scheme and coding ratio of the error correction; the primary modulation in accordance with a selected and switched multi-level modulation scheme; and the secondary modulation in accordance with a selected and switched band-broadening scheme. With the information data being thus divided onto the plural transmission sub-channels, the speed of the processing operation on each transmission sub-channel can be lowered, thereby allowing the implementation of the faster data transmission. Similarly, in the reception unit as well, the data division onto the plural reception sub-channels lowers speeds of the processing operations by the secondary demodulation, the primary demodulation, and the error-correction decoding on each reception sub-channel basis after the received frequency-multiplexed signal has been demultiplexed. This also allows the implementation of the faster data transmission. In other words, even in the AD converter and the DA converter used for the coding, the primary modulation, and the secondary modulation in the transmission unit, or the decoding, the primary demodulation, and the secondary demodulation in the reception unit, it becomes possible to implement the faster data transmission with the employment of low-speed component parts alone.

Also, the switching of the number of the sub-channels and the switching of the band-broadening scheme of the secondary modulator are performed in combination with the selection and switching of the coding scheme and coding ratio of the coder and the selection and switching of the multi-level modulation scheme of the primary modulator. This allows the detailed adaptive control to be performed in response to the various transmission conditions and the variations in the transmission situation and traffic situation on the transmission path, thereby making it possible to enhance the frequency utilization efficiency even further.

Accordingly, it becomes possible to transmit the faster information data with a high efficiency in response to the different transmission conditions such as the situation on the transmission path, many types of media, or many types of services.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram for illustrating the configuration of the transmission unit of an embodiment of the code-modulation adaptive and variable multiplexing transmission apparatus according to the present invention;

FIG. 2 is a block diagram for illustrating the configuration of the reception unit of an embodiment of the code-modulation adaptive and variable multiplexing transmission apparatus according to the present invention;

FIG. 3 is a block diagram for illustrating the configuration of the transmission unit of the code-modulation adaptive and variable transmission apparatus that the present inventor considered in the process of attaining the present invention;

FIG. 4 is a block diagram for illustrating the configuration of the reception unit of the code-modulation adaptive and variable transmission apparatus that the present inventor considered in the process of achieving the present invention;

FIG. 5 is a diagram for illustrating an example of the packet transmission/reception timing operation in the embodiment of the code-modulation adaptive and variable multiplexing transmission apparatus according to the present invention;

FIG. 6 is a block diagram for illustrating the configuration of an example of a coder in the transmission unit of the code-modulation adaptive and variable multiplexing transmission apparatus in FIG. 1;

FIG. 7 is a block diagram for illustrating the configuration of an example of a primary modulator in the transmission unit of the code-modulation adaptive and variable multiplexing transmission apparatus in FIG. 1;

FIG. 8 is a block diagram for illustrating the configuration of an example of a secondary modulator in the transmission unit of the code-modulation adaptive and variable multiplexing transmission apparatus in FIG. 1;

FIG. 9 is a diagram for explaining an example of the sub-channel frequency multiplexing in a frequency multiplexing circuit in the transmission unit of the code-modulation adaptive and variable multiplexing transmission apparatus in FIG. 1; and

FIG. 10 is a diagram for explaining another example of the sub-channel frequency multiplexing in the frequency multiplexing circuit in the transmission unit of the code-modulation adaptive and variable multiplexing transmission apparatus in FIG. 1.

### DESCRIPTION OF THE EMBODIMENTS

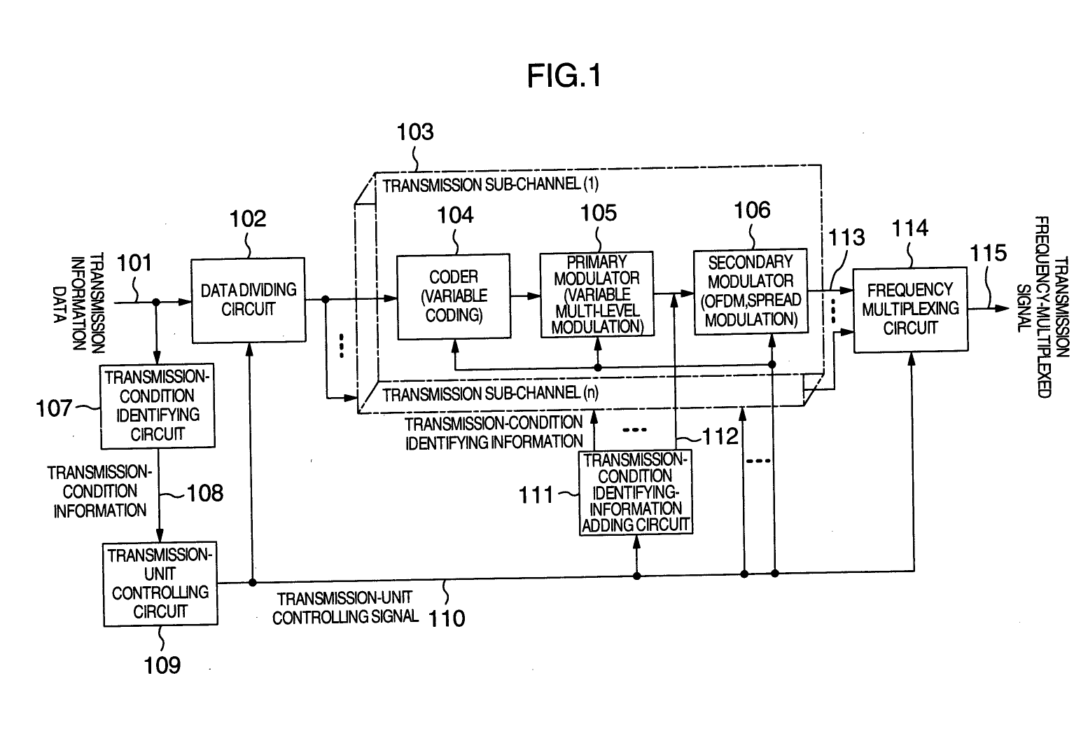

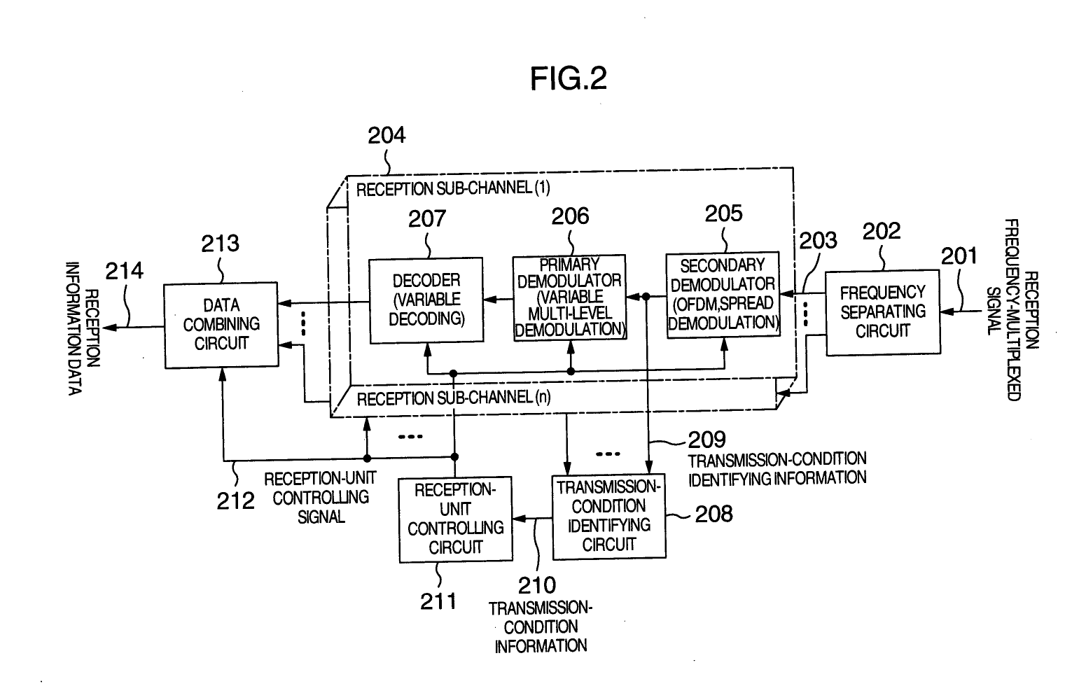

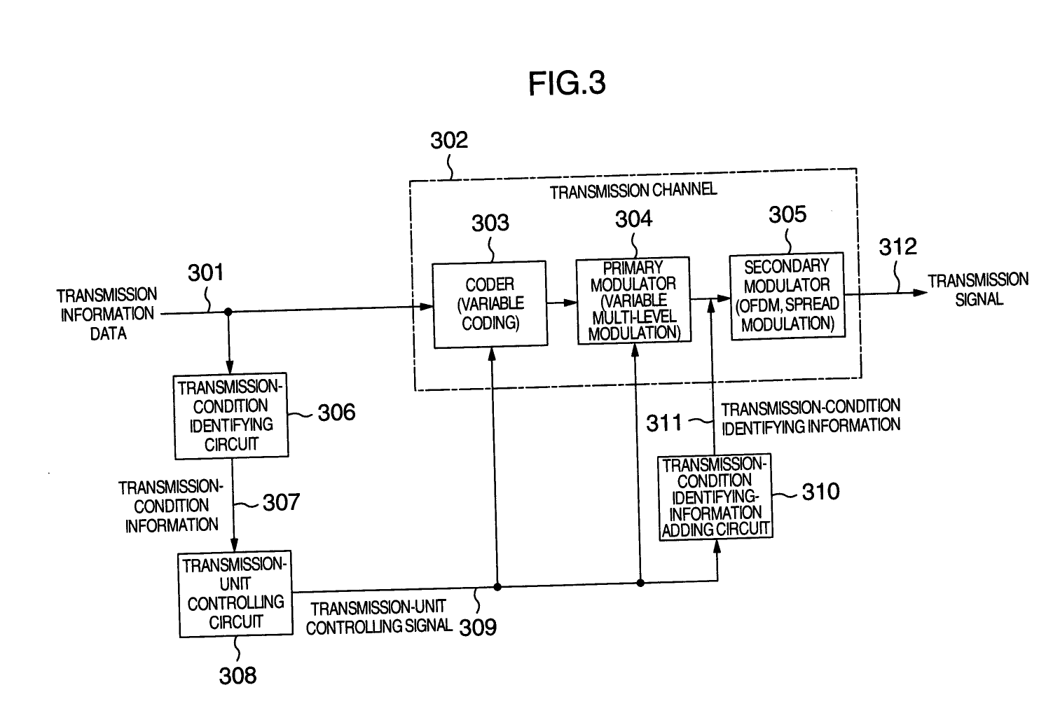

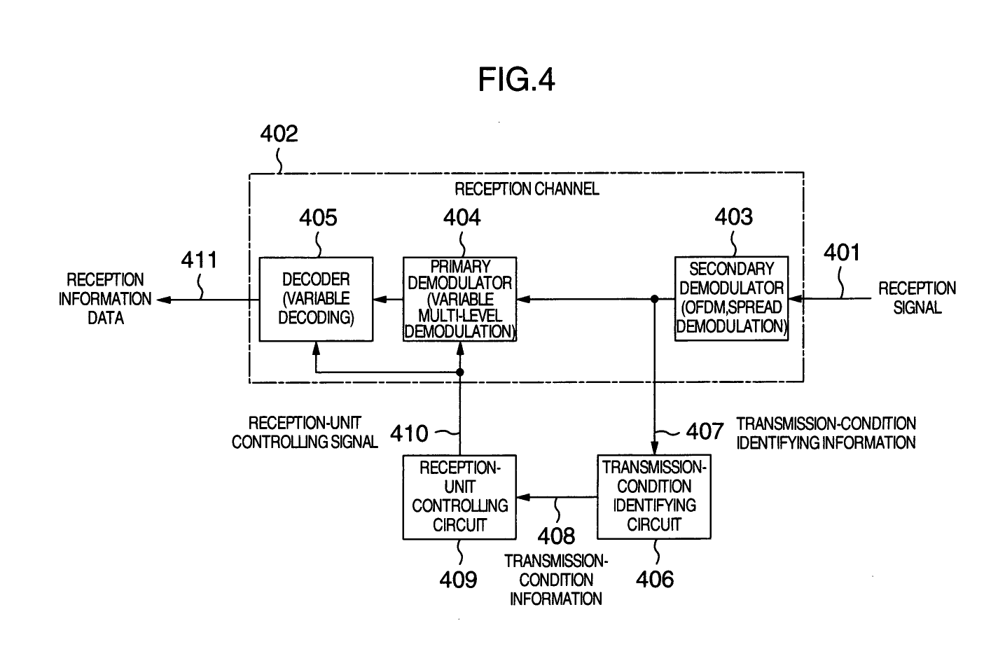

Hereinafter, referring to FIG. 1 and FIG. 2, explanation will be given below concerning an embodiment of the code-modulation adaptive and variable multiplexing transmission apparatus according to the present invention. Here, this embodiment divides information data into signals on plural sub-channels, and frequency-multiplexes the signals on the plural sub-channels to transmit them as a channel for one and the same user.

FIG. 1 is a block diagram for illustrating the configuration of the transmission unit of an embodiment of the code-modulation adaptive and variable multiplexing transmission apparatus according to the present invention. The transmission unit includes a transmission-condition identifying circuit 107 for identifying transmission-condition information 108 on the basis of data rate, data capacity of inputted transmission information data 101 in units of a slot or a packet, or transmission-condition specifying information included in the information data, a transmission-unit controlling circuit 109 to which the transmission-condition information 108 identified in the transmission-condition identifying circuit 107 is supplied, a data dividing circuit 102 for dividing the transmission information data 101 into transmission signals on plural transmission sub-channels (1) to (n) 103 in accordance with a transmission-unit controlling signal 110 from the transmission-unit controlling circuit 109, a coder 104 for performing an error-correction coding in accordance with a desired coding scheme and a desired coding ratio that, based on the transmission-unit controlling signal 110 from the transmission-unit controlling circuit 109, are selected and switched from among plural coding schemes (i.e., coding schemes such as convolutional coding, Reed-Solomon coding, and BCH (Bose-Chaudhuri-Hocquenghem) coding) and plural coding ratios prepared in advance (i.e., provided as circuits of the coder) on each of the transmission sub-channels (1) to (n) 103, a primary modulator 105 for performing a primary modulation in accordance with a desired multi-level modulation scheme that, based on the transmission-unit controlling signal 110 that follows the transmission-condition information 108 from the transmission-unit controlling circuit 109, is selected and switched from among plural multi-level modulation schemes (i.e., modulation schemes such as QPSK including BPSK, and 16QAM) prepared in advance (i.e., provided as circuits of the modulator) on each of the transmission sub-channels (1) to (n) 103, a transmission-condition-identifying-information adding circuit 111 for adding, to the transmission signal on each of the transmission sub-channels (1) to (n) 103, transmission-condition identifying information 112 corresponding to the transmission-condition information 108 set up by the transmission-unit controlling circuit 109, a secondary modulator 106 for performing a secondary modulation in accordance with a desired band-broadening scheme that, based on the transmission-unit controlling signal 110 from the transmission-unit controlling circuit 109, is selected and switched from among plural band-broadening schemes (i.e., band-broadening schemes such as OFDM (Orthogonal Frequency Division Multiplex) and spread modulation (i.e., spectrum spreading) prepared in advance (i.e., provided as circuits of the modulator) on each of the transmission sub-channels (1) to (n) 103, and a frequency multiplexing circuit 114 for frequency-multiplexing transmission modulated signals 113 acquired from the plural transmission sub-channels (1) to (n) 103.

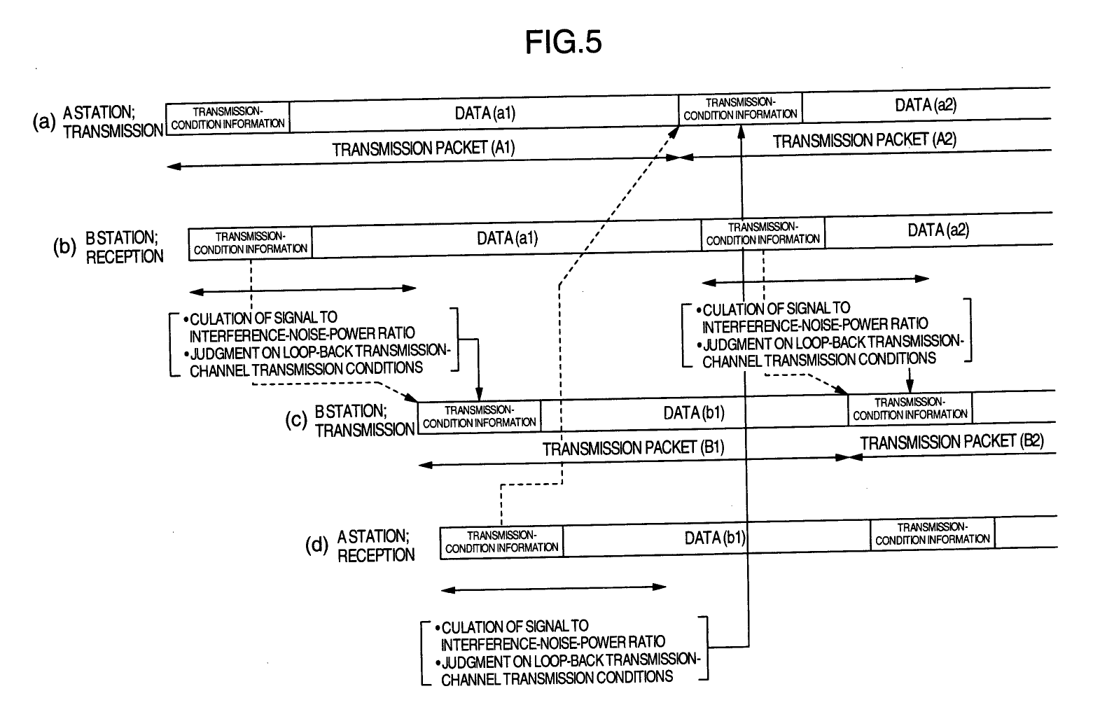

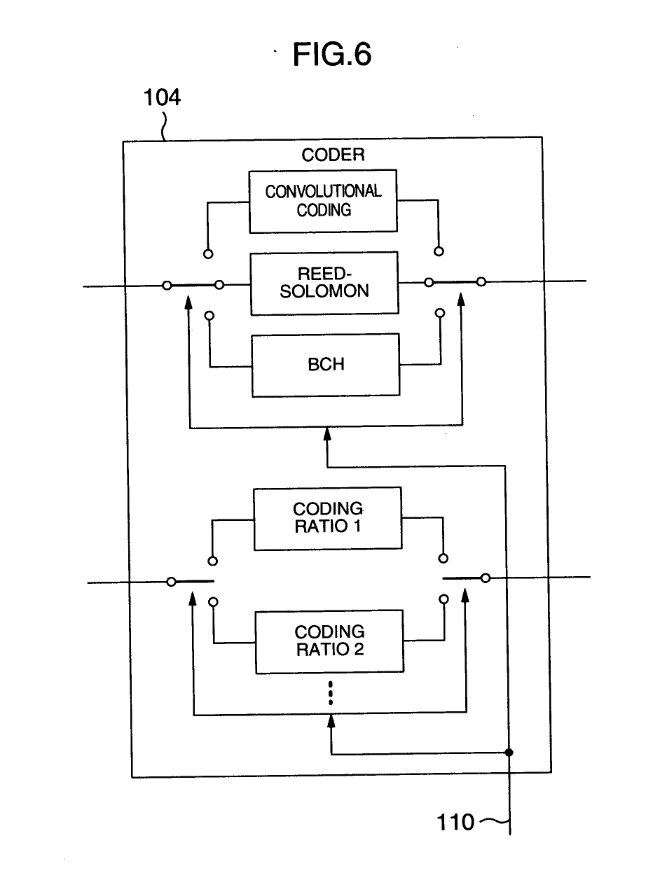

FIG. 6 illustrates one configuration example of the coder 104. This coder 104 is arranged such that, based on the transmission-unit controlling signal 110 from the transmission-unit controlling circuit 109, the coder 104 selects a desired coding scheme and coding ratio from among the plural coding schemes and coding ratios prepared in advance.

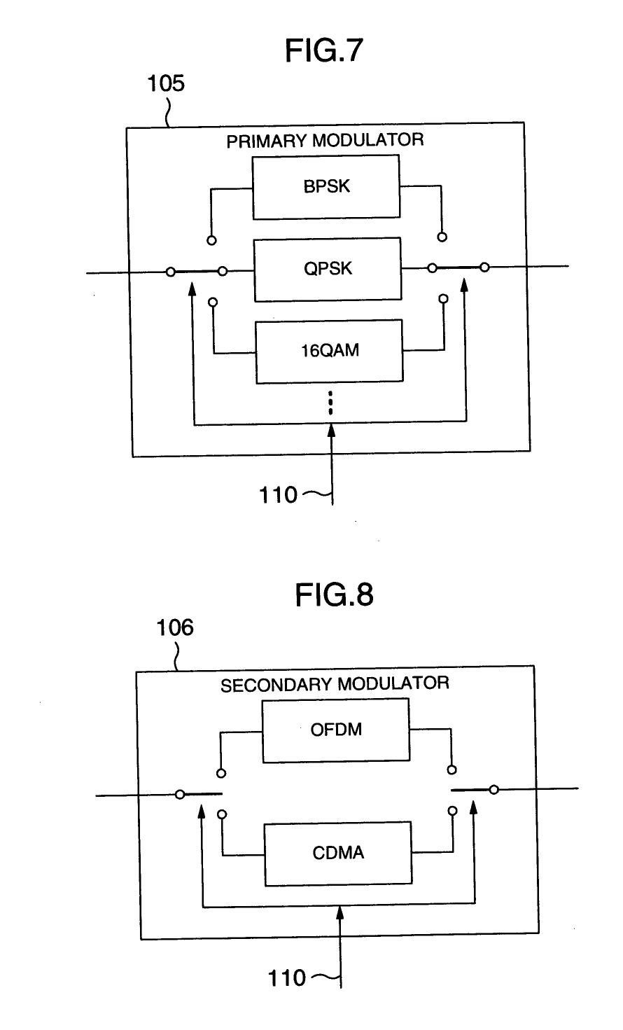

FIG. 7 illustrates one configuration example of the primary modulator 105. This primary modulator 105 is arranged such that, based on the transmission-unit controlling signal 110 from the transmission-unit controlling circuit 109, the primary modulator 105 selects a desired multi-level modulation scheme from among the plural multi-level modulation schemes prepared in advance.

FIG. 8 illustrates one configuration example of the secondary modulator 106. This secondary modulator 106 is arranged such that, based on the transmission-unit controlling signal 110 from the transmission-unit controlling circuit 109, the secondary modulator 106 selects a desired band-broadening scheme from among the plural band-broadening schemes prepared in advance.

The data dividing circuit 102 is a circuit for dividing the transmission information data 101 onto the plural transmission sub-channels (1) to (n) 103 in an equal proportion or a different proportion in accordance with the transmission-unit controlling signal 110 based on the transmission-condition information 108 from the transmission-unit controlling circuit 109. In the case of, e.g., 4 sub-channels and also in the case of the equal-proportion division, the data dividing circuit 102 divides out 1 piece of transmission information data onto each sub-channel every time 4 pieces of transmission information data are inputted. Meanwhile, in the case of the different-proportion division (e.g., a ratio of 1:2:3:4), the circuit 102 divides out 1 piece of data, 2 pieces of data, 3 pieces of data, and 4 pieces of data onto each of the 4 sub-channels respectively every time 10 pieces of transmission information data are inputted. Also, the reason for the employment of the term “sub-channels” is to indicate that the plural sub-channels are frequency-multiplexed so as to be used as one channel by one user.

Here, the coder 104, the primary modulator 105, and the secondary modulator 106 become necessary for each of the transmission sub-channels (1) to (n) 103. The transmission-condition-identifying-information adding circuit 111 adds the transmission-condition identifying information 112 to each of the transmission sub-channels (1) to (n) 103, or to one or plural transmission sub-channels to be specified in a batch manner (the transmission-condition identifying information 112 is added as data such as a command which is abbreviated as much as possible). Note that this transmission-condition identifying information 112 is added as a fixed band-broadening scheme of the secondary modulator 106 which has been decided or agreed in advance between the transmission side and the reception side and specified by them.

When the transmission information data 101 in units of a slot or a packet is inputted into the transmission unit configured as described above, based on the data rate and data capacity of the transmission information data 101, or the transmission-condition specifying information included in the information data, the transmission-condition identifying circuit 107 identifies the transmission-condition information 108, then outputs the identified transmission-condition information 108 to the transmission-unit controlling circuit 109. Here, the transmission-condition information 108 indicates the following information: The error-correction coding scheme (i.e., coding scheme such as convolutional coding, Reed-Solomon coding, or BCH (Bose-Chaudhuri-Hocquenghem) coding) and the error-correction coding ratio on each sub-channel, the multi-level modulation scheme in the primary modulation on each sub-channel, the band-broadening scheme in the secondary modulation on each sub-channel, and the number of the sub-channels divided and frequency-multiplexed. Incidentally, the convolutional coding is one type of the error-correction coding schemes. The codes are generated based on plural information blocks. This coding scheme has been developed in connection with the decoding methods. The decoding methods include the threshold-value decoding method and the maximum-likelihood decoding method. The Reed-Solomon coding, which is one type of the error-correction coding schemes and one of the burst-error detecting/correcting block coding schemes, is utilized in communications and data recording. The block coding schemes refer to methods of dividing information bits to be transmitted into blocks in a certain size and adding parity bits (i.e., error detecting bits) thereto on each block basis. In addition thereto, as the burst-error detecting/correcting coding schemes, there exist the fire coding scheme and the like. Also, as the random-error correcting coding schemes, there exist the BCH coding, the Hamming coding, the cyclic coding, the Golay coding, and the like. Incidentally, independently of the block coding schemes, there exists the convolutional coding scheme. This is the scheme where the exclusive-OR logical-sum computational processing and the like are performed on several input-bits basis without dividing the information bits into the blocks. Here, the transmission-condition identifying circuit 107 may also output the above-described transmission-condition information 108 to the transmission-unit controlling circuit 109 by accepting transmission-condition information 210 from a transmission-condition identifying circuit 208 in the reception unit which will be described later. Also, although the illustration is omitted, a unit for monitoring the transfer situation and traffic situation on the transmission path may be provided so as to output the transmission-condition information 108 responding to the transmission-line situation to the transmission-unit controlling circuit 109.

The transmission-unit controlling circuit 109, based on the transmission-condition information 108, performs the control of causing the data dividing circuit 102 to divide the transmission information data 101 onto the respective transmission sub-channels (1) to (n) 103 in the equal proportion or the different proportion. In addition, the controlling circuit 109, in accordance with the transmission-condition information 108, performs the control of selecting and switching the coding scheme and coding ratio of the coder 104, the multi-level modulation scheme of the primary modulator 105, and the band-broadening scheme of the secondary modulator 106 for each of the transmission sub-channels (1) to (n) 103. Also, the controlling circuit 109 performs the control of causing the transmission-condition-identifying-information adding circuit 111 to add the transmission-condition identifying information 112 to be transmitted to the transmission signals.

By executing the above-described controls, the transmission information signal on each of the transmission sub-channels (1) to (n) 103 is inputted into the coder 104, then being coded in accordance with the selected and switched coding scheme and coding ratio. Then, in the primary modulator 105, the coded signal is primary-modulated in accordance with the selected and switched multi-level modulation scheme. Next, in the transmission-condition-identifying-information adding circuit 111, the transmission-condition identifying information 112 converted into a command or the like is added to the primarily-modulated signal. Then, in the secondary modulator 106, the signal is secondary-modulated in accordance with the selected and switched band-broadening scheme, sot that the transmission modulated signals 113 are outputted from the plural transmission sub-channels (1) to (n) 103.

The transmission modulated signals 113 from the plural transmission sub-channels (1) to (n) 103 are frequency-multiplexed by the frequency multiplexing circuit 114 so as to be transmitted as a resultant transmission multiplexed signal 115, then being received at the reception unit.

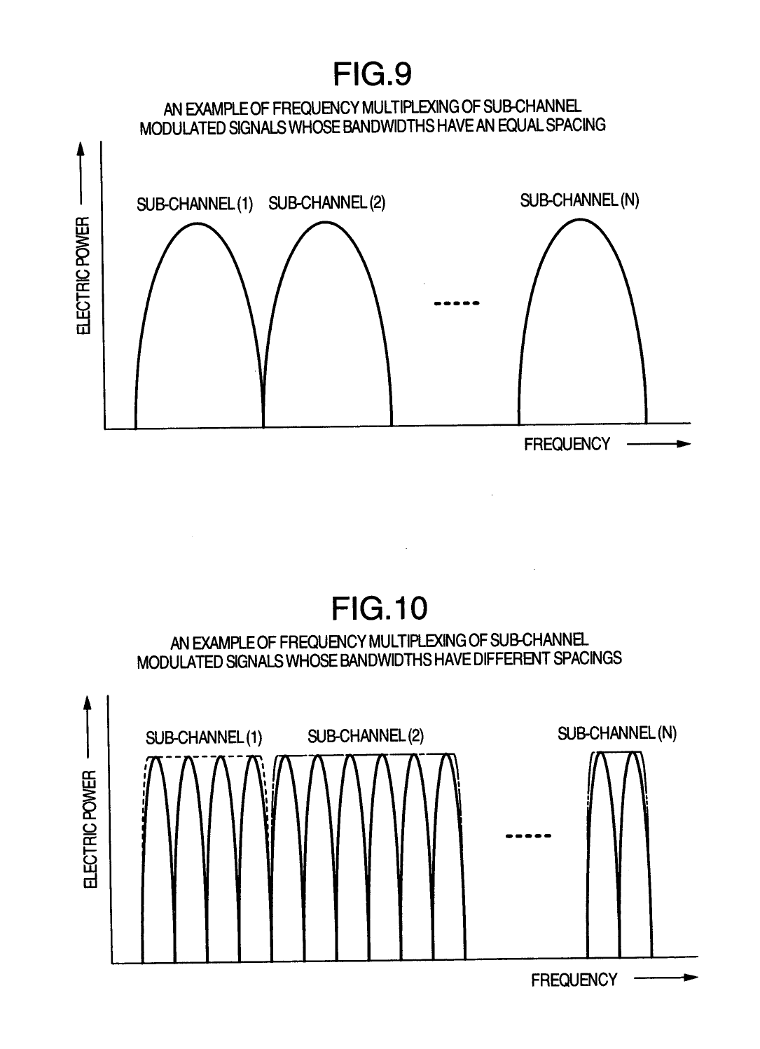

Now, using frequency multiplexing examples of the sub-channel modulated signals in FIG. 9 and FIG. 10, explanation will be given below regarding the frequency multiplexing in the frequency multiplexing circuit 114. The frequency multiplexing is the following processing: The modulated signals on the respective sub-channels are each multiplied by carrier-wave signals so that channel bands of the respective sub-channel modulated signals are arranged in the frequency direction in such a manner that the channel bands will not overlap with each other.

FIG. 9 illustrates the case where the channel bandwidths of the sub-channel modulated signals have an equal spacing. The sub-channel modulated signals are each multiplied by carrier-wave signals having the equal spacing, thereby arranging the channel bands in the frequency direction with the equal spacing. This frequency-multiplexes the signals, thereby converting the signals into one signal.

In the sub-channel modulated signals in the OFDM modulation scheme where, as illustrated in FIG. 10, the numbers of the sub-channels differ, the channel bandwidths of the signals have different spacings. Accordingly, the sub-channel modulated signals are each multiplied by carrier-wave signals having the different frequency spacings, thereby arranging the channel bands in the frequency direction in such a manner that the channel bands will not overlap with each other. This frequency-multiplexes the signals, thereby converting the signals into one signal.

Incidentally, in all of the plural transmission sub-channels (1) to (n) 103 to be frequency-multiplexed in the above-described embodiment, the coders 104 may use one and the same coding scheme and coding ratio, and the primary modulators 105 may use one and the same multi-level modulation scheme, and the secondary modulators 106 may use one and the same band-broadening scheme. In this case, it is a matter of course that, based on the transmission-unit controlling signal 110 acquired from the transmission-unit controlling circuit 109, the coders 104 may select and use one and the same coding scheme and coding ratio, and the primary modulators 105 may select and use one and the same multi-level modulation scheme, and the secondary modulators 106 may select and use one and the same band-broadening scheme.

Also, the large number of transmission sub-channels (1) to (n) 103 to be frequency-multiplexed in the above-described embodiment may be divided into plural groups in correspondence with, e.g., plural users. In plural sub-channels on each divided-group basis, the coders 104 may use one and the same coding scheme and coding ratio, and the primary modulators 105 may use one and the same multi-level modulation scheme, and the secondary modulators 106 may use one and the same band-broadening scheme. In this case as well (i.e., in the plural sub-channels on each divided-group basis as well), it is a matter of course that, based on the transmission-unit controlling signal 110 acquired from the transmission-unit controlling circuit 109, the coders 104 may select and use one and the same coding scheme and coding ratio, and the primary modulators 105 may select and use one and the same multi-level modulation scheme, and the secondary modulators 106 may select and use one and the same band-broadening scheme.

FIG. 2 is a block diagram for illustrating the configuration of the reception unit of the embodiment of the code-modulation adaptive and variable multiplexing transmission apparatus according to the present invention. The reception unit includes a frequency-demultiplexing circuit 202 for frequency-separating the received reception frequency-multiplexed signal 201 into each of the reception modulated signals 203 on each of reception sub-channels (1) to (n) 204, a transmission-condition identifying circuit 208 for identifying the transmission-condition information 210 added on the transmission side, the transmission-condition information 210 including the error-correction coding scheme and coding ratio, the multi-level modulation scheme in the primary modulation, the band-broadening scheme in the secondary modulation on each of the transmission sub-channels (1) to (n) 103, and the number of the transmission sub-channels, a reception-unit controlling circuit 211 for performing, based on the identified transmission-condition information 210, controls of a secondary demodulator 205, a primary demodulator 206, and a decoder 207 that are provided on each reception sub-channel basis and a control of a data combining circuit 213 which operates to combine information data from the plural reception sub-channels (1) to (n) 204. Here, the secondary demodulator 205, the primary demodulator 206, and the decoder 207 become necessary for each of the reception sub-channels (1) to (n) 204.

When the reception frequency-multiplexed signal 201 is inputted into the reception unit configured as described above, the frequency-multiplexed signal 201 is frequency-separated or demultiplexed by the frequency demultiplexing circuit 202 into the reception modulated signals 203 on the plural reception sub-channels (1) to (n) 204. Next, in the secondary demodulator 205 on each of the reception sub-channels (1) to (n) 204, the modulated signal 203 is secondary-demodulated in accordance with a band-debroadening scheme selected and switched by the reception-unit controlling circuit 211. This restores the modulated signal 203 back to the primary-modulated signal. Incidentally, the number n of the reception sub-channels is the number of the transmission sub-channels included in the identified transmission-condition information 210.

This primary-modulated signal is supplied to the transmission-condition identifying circuit 208 which identifies the transmission-condition identifying information 209 added on the transmission side and inputs the transmission-condition information 210 to the reception-unit controlling circuit 211. The reception-unit controlling circuit 211, in accordance with the transmission-condition information 210, performs the control of selecting and switching the band-debroadening scheme of the secondary demodulator 205, the multi-level demodulation scheme of the primary demodulator 206, and the decoding scheme and coding ratio of the decoder 207 on each of the reception sub-channels (1) to (n) 204 so that the band-debroadening scheme, the multi-level demodulation scheme, and the decoding scheme and coding ratio match the band-broadening scheme of the secondary modulator 106, the multi-level modulation scheme of the primary modulator 105, and the coding scheme and coding ratio of the coder 104 on each of the transmission sub-channels (1) to (n) 103 in the transmission unit.

As having been described in the explanation of the transmission unit, the transmission-condition identifying information 209 has been added as a fixed band-broadening scheme of the secondary modulator 106 which has been decided or agreed in advance between the transmission side and the reception side and specified by them. Accordingly, the band-debroadening scheme of the secondary demodulator 205 is switched to the scheme that matches the scheme decided in advance and specified with respect to the transmission-condition identifying information 209, and is switched to the scheme based on the transmission-condition information 210 with respect to the information data. Also, in the transmission unit, the transmission-condition identifying information has been added to each of the transmission sub-channels, or to the one or plural transmission sub-channels specified in the batch manner. Consequently, in the reception unit, from corresponding reception sub-channel or from corresponding one or plural transmission sub-channels, the transmission-condition identifying information 209 is identified by the transmission-condition identifying circuit 208.

In the primary demodulator 206, the primary-modulated signal outputted from the secondary demodulator 205 is primary demodulated in accordance with the multi-level demodulation scheme selected and switched based on a reception-unit controlling signal 212 from the reception-unit controlling circuit 211 and is decoded in accordance with the selected and switched decoding scheme and coding ratio in the decoder 207 to eventually reproduce the reception information on the respective reception sub-channels (1) to (n) 204. These plural pieces of reception information on the reception sub-channels (1) to (n) 204 are combined by the data combining circuit 213 to output the reception information data 214.

By the way, as methods of transmitting the transmission-condition identifying information 112 from the transmission unit to the reception unit, there exist the following methods. A first method is such that, when the information data is transmitted in units of a slot or in units of a packet including plural slots, the transmission is performed in a state where the transmission-condition identifying information 112 is added to the front-head (i.e., header) of the slot or the packet so that the transmission-condition information is identified from the front-head of the slot or the packet received. A second method is such that the transmission is performed in a state where the transmission-condition identifying information 112 is added to a pilot channel or the like to be code-multiplexed or frequency-multiplexed so that the transmission-condition information is identified from the pilot channel received. As still other methods, there exist a method where the transmission-condition identifying information 112 is transmitted beforehand in a slot or a packet which is one slot or one packet ahead in time.

FIG. 5 is a diagram for illustrating an example of the packet transmission/reception timing operation between an A station and a B station each of which includes the above-described transmission unit (FIG. 1) and the above-described reception unit (FIG. 2). Incidentally, here, it is assumed that each station transmits/receives data in units of a packet such as a slot including plural pieces of transmission data, or a frame including a plurality of the slots. Accordingly, as described earlier, the data is transmitted in the state where the transmission-condition information is added to the front-head of each packet. In FIG. 5, the transverse direction is the time axis. Also, reference notations (a), (b), (c), and (d) denote transmission data by the A station, the reception data by the B station, transmission data by the B station, and the reception data by the A station, respectively. Here, it is assumed that, in an initial state, the number of the frequency-multiplexed channels, the primary modulation, and the secondary modulation used for the information transmission from the A station are defined as initial set-up values determined in advance based on the type of the data and the like.

As illustrated in (a) in FIG. 5, the A station transmits a transmission packet A1 including the transmission-condition information and the data a1. As illustrated in (b), this packet is received by the B station. Next, the transmission-condition information included in the transmission packet A1 is extracted by the transmission-condition identifying circuit 208 in the reception unit of the B station, and then supplied to the transmission-unit controlling circuit 109 in the transmission unit of the B station. This, as illustrated in (c), allows the B station to transmit a transmission packet B1 of its own station with the use of the channels in the number set up based on the transmission-condition information and the primary modulation and the secondary modulation set up based thereon. Also, a signal-to-interference-noise-power ratio calculating circuit (not illustrated) in the reception unit of the B station calculates a signal-to-interference-noise-power ratio from the reception signal in the received transmission packet A1. Subsequently, based on the calculated result, a loop-back transmission-channel transmission-condition judging circuit (not illustrated) generates loop-back transmission-channel transmission-condition information, then storing this information into a reception-channel transmission-condition information memory (not illustrated) and supplying this information to the transmission-condition-identifying-information adding circuit 111 in the transmission unit. This, as illustrated in (c), allows the loop-back transmission-channel transmission-condition information to be transmitted in a manner of being added into the transmission packet B1 transmitted by the B station.

As illustrated in (d) in FIG. 5, this transmission packet B1 is received by the A station. Next, in the reception unit of the A station, similarly in the reception unit of the B station, the number of the frequency-multiplexed channels, the primary modulation, and the secondary modulation for a next transmission packet A2 are set up based on the transmission-condition information fetched by the transmission-condition identifying circuit 208. Also, the loop-back transmission-channel transmission-condition judging circuit generates loop-back transmission-channel transmission-condition information to be specified for the B station, then transmitting this information in a manner of being added to the transmission packet A2. Moreover, when the B station has received this transmission packet A2, similarly in the above-described case, the B station fetches the transmission-condition information stored in the transmission packet A2, then setting up this information into the transmission-unit controlling circuit 109, and generating loop-back transmission-channel transmission-condition information to be specified for the A station. Incidentally, at this time, the B station performs set-up of the secondary demodulator 205, the primary demodulator 206, and the data combining circuit 213, using the loop-back transmission-channel transmission-condition information generated when receiving the transmission packet A1 and stored into the reception-channel transmission-condition information memory (not illustrated).

In the code-modulation adaptive and variable multiplexing transmission apparatus according to the present invention explained above, in the transmission unit, the transmission information data is divided onto the plural sub-channels. Next, the following operations are performed on each sub-channel basis: The coding of the error correction, the primary modulation in accordance with the multi-level modulation scheme, and the secondary modulation in accordance with the band-broadening scheme. This (i.e., the information data is divided onto the plural sub-channels) lowers speeds of the processing operations on each transmission sub-channel. Similarly, in the reception unit as well, the data division onto the plural reception sub-channels lowers speeds of the processing operations by the secondary demodulation, the primary demodulation, and the decoding on each reception sub-channel basis after the received frequency-multiplexed signal has been separated. Furthermore, even in the AD converter and the DA converter in the coder, the primary modulator, and the secondary modulator or the secondary demodulator, the primary demodulator, and the decoder, it becomes possible to implement the higher-speed data transmission with the employment of low-speed configuration components alone.

Also, the switching of the number of the sub-channels and the switching of the band-broadening scheme by the secondary modulator are performed in combination with the selection and switching of the coding scheme and coding ratio by the coder and the ones of the multi-level modulation scheme by the primary modulator. This allows the detailed adaptive control to be performed in response to the various transmission conditions and the variations in the transfer situation and traffic situation on the transmission line, thereby making it possible to enhance the frequency utilization efficiency even further.

Accordingly, it becomes possible to transmit the faster information data with a high efficiency in response to the different transmission conditions such as the situation on the transmission path, many types of media, or many types of services.

As having been explained, the above-described embodiment lowers the speeds of the processing operations by the coding, the primary modulation, and the secondary modulation in the transmission unit, or by the decoding, the primary demodulation, and the secondary demodulation in the reception unit. This, even in the AD converter and the DA converter where the speeding-up is difficult to accomplish, allows the implementation of the higher-speed data transmission with the employment of the low-speed component parts alone. Consequently, it becomes possible to implement the transmission apparatus that allows the implementation of the faster data transmission.

Also, the above-described embodiment allows the more detailed adaptive control to be performed in response to the various transmission conditions and the variations in the transmission situation and traffic situation on the transmission path. This makes it possible to implement the transmission apparatus that allows the faster information data to be transmitted with a high efficiency in response to the different transmission conditions such as many types of media or many types of services.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A code-modulation adaptive and variable multiplexing transmission apparatus, comprising:
a data dividing circuit for dividing transmission data into transmission signals on plural transmission sub-channels;
a primary modulator and a secondary modulator provided for each of said plural transmission sub-channels, said primary modulator performing a multi-level modulation to a transmission signal on said transmission sub-channel transmitted from said data dividing circuit, said secondary modulator performing a transmission-band-broadening on a multi-level-modulated signal acquired from said primary modulator;
an addition circuit for adding transmission-condition information to each transmission signal of an associated transmission sub-channel, said transmission-condition information including a multi-level modulation scheme of said primary modulator and a band-broadening scheme of said secondary modulator for each of said plural transmission sub-channels, and the number of said plural transmission sub-channels; and
a frequency multiplexing circuit for frequency-multiplexing band-broadened multi-level-modulated outputs acquired from the respective secondary modulators on said plural transmission sub-channels, and outputting a resultant frequency-multiplexed signal as a channel for a user.

2. The apparatus according to claim 1, wherein said primary modulator provided for each of said plural transmission sub-channels is arranged to select an arbitrary multi-level modulation scheme from among plural multi-level modulation schemes, said secondary modulator provided for each of said plural transmission sub-channels being arranged to select an arbitrary band-broadening scheme from among plural band-broadening schemes.

3. The apparatus according to claim 2, wherein said plural multi-level modulation schemes include BPSK, QPSK, and 16QAM, said plural band-broadening schemes including OFDM and spectrum spreading.

4. The apparatus according to claim 1, wherein said primary modulators provided for said respective plural transmission sub-channels are arranged to use one and the same multi-level modulation scheme on said plural transmission sub-channels, said secondary modulators being also arranged to use one and the same band-broadening scheme on said plural transmission sub-channels.

5. The apparatus according to claim 1, wherein said plural transmission sub-channels are divided into plural groups of transmission sub-channels, said primary modulators provided for said respective plural transmission sub-channels being arranged to use one and the same multi-level modulation scheme within one and the same group of transmission sub-channels, said secondary modulators being also arranged to use one and the same band-broadening scheme within one and the same group of transmission sub-channels.

6. The apparatus according to claim 5, wherein respective ones of said plural groups of transmission sub-channels constitute respective channels that are allocated to different users.

7. The apparatus according to claim 1, further comprising a coder provided at a preceding stage of said primary modulator provided for each of said plural transmission sub-channels, said coder performing an error-correction coding on said transmission signal on a transmission sub-channel associated therewith, said primary modulator performing said multi-level modulation to output data outputted from said coder.

8. The apparatus according to claim 7, wherein said transmission-condition information added by said addition circuit to said transmission signal associated therewith further includes a coding scheme and a coding ratio used by said coder on said transmission sub-channel associated therewith.

9. The apparatus according to claim 7, wherein said coder is arranged to select an arbitrary error-correction coding scheme and an arbitrary coding ratio from among plural error-correction coding schemes and plural coding ratios, respectively.

10. The apparatus according to claim 9, wherein said plural error-correction coding schemes include convolutional coding, Reed-Solomon, and BCH.

11. A code-modulation adaptive and variable multiplexing transmission apparatus, comprising:
a controlling circuit for generating a controlling signal based on transmission-condition information;
a data dividing circuit for dividing transmission data into each of transmission signals for each of plural transmission sub-channels;
a primary modulator provided for each of said plural transmission sub-channels and a secondary modulator connected to said primary modulator, wherein said primary modulator, responsive to said controlling circuit, selects a multi-level modulation scheme from among plural multi-level modulation schemes thereby to multi-level modulate a transmission signal associated therewith, and, said secondary modulator, responsive to said controlling circuit, selects a band-broadening scheme from among plural band-broadening schemes thereby to band-broaden a multi-level-modulated signal acquired from said primary modulator;
an addition circuit for adding said transmission-condition information to said transmission signal associated therewith, said transmission-condition information including a multi-level modulation scheme by said primary modulator, a band-broadening scheme by said secondary modulator, and the number of said plural transmission sub-channels, said multi-level modulation scheme and said band-broadening scheme being performed for each of said plural transmission sub-channels; and
a frequency multiplexing circuit for frequency-multiplexing band-broadened multi-level-modulated outputs, and outputs a resultant frequency-multiplexed signal as a channel for one and the same user, said outputs being acquired from said respective secondary modulators on said plural transmission sub-channels.

12. A code-modulation adaptive and variable multiplexing transmission apparatus, comprising:
a frequency separating circuit for frequency-separating a received frequency-multiplexed signal into a modulated signal for each of plural reception sub-channels;
a transmission-condition identifying circuit for identifying transmission-condition information added on a transmission side, said transmission-condition information including a multi-level modulation scheme in the primary modulation for each reception sub-channel, a band-broadening scheme in the secondary modulation for each reception sub-channel, and a number of reception sub-channels;
a controlling circuit for generating a controlling signal based on said transmission-condition information identified in said transmission-condition identifying circuit;
a secondary demodulator and a primary demodulator both provided for each of said plural reception sub-channels, wherein said secondary demodulator, responsive to said controlling circuit, demodulates a modulated signal of associated reception sub-channel acquired from said frequency separating circuit with a band-debroadening scheme corresponding to said band-broadening scheme identified in said transmission-condition identifying circuit, and wherein said primary demodulator, responsive to said controlling circuit, demodulates a signal from said secondary demodulator with a multi-level demodulation scheme corresponding to said multi-level modulation scheme identified in said transmission-condition identifying circuit; and
a data combining circuit for combining data acquired from said plural reception sub-channels.

13. A code-modulation adaptive and variable multiplexing transmission method, comprising the steps of:
dividing transmission data into transmission signals on plural transmission sub-channels;
performing a multi-level modulation to each of said transmission signals on said plural transmission sub-channels;
performing a transmission-band-roadening to each of multi-level-modulated signals on said plural transmission sub-channels;
adding transmission-condition information to each transmission signal, said transmission-condition information including a modulation scheme of said multi-level modulation, a modulation scheme of said band-broadening, and the number of said plural transmission sub-channels; and
frequency-multiplexing band-broadened modulated outputs on said plural transmission sub-channels, and outputting a resultant signal as a channel for one and the same user.

14. A code-modulation adaptive and variable multiplexing transmission method, comprising the step of:
frequency-separating a received frequency-multiplexed signal into a modulated signal for each of plural reception sub-channels by using a frequency separating circuit;
identifying transmission condition information added on transmission side in a signal on each of the transmission sub-channels by using a transmission condition identifying circuit, said information including a multi-level modulation scheme in a primary modulation and a band-broadening scheme in a secondary modulation performed on transmission side and a number of transmission sub-channels;
demodulating the modulated signal on each of reception sub-channels obtained from said frequency-separating circuit into a modulated signal by using an associated one of secondary demodulators provided one for each of said plurality reception sub-channels with a band-debroadening scheme corresponding to the band broadening scheme identified by said transmission condition identifying circuit;
demodulating said modulated signal on each of reception sub-channels obtained from said associated secondary demodulator by using an associated one of primary demodulators provided one for each of said plural reception sub-channels with a multi-level demodulating scheme corresponding to the multi-level modulating scheme identified by said transmission condition identifying circuit; and
combining data acquired from said plural reception sub-channels.
